(19) United States
(12) Patent Application Publication
(10) Pub. No.: US 2017/0022906 A1
(43) Pub. Date: Jan. 26, 2017

(54) METHOD FOR ISOLATING A COMBUSTIBLE FLUID TANK FROM A DOWNSTREAM PORTION OF A TURBOMACHINE SUPPLY SYSTEM IN CASE OF A FIRE, AND SUCH A SUPPLY SYSTEM

(71) Applicant: SNECMA, Paris (FR)

(72) Inventors: Thomas LEPAGE, Paris (FR); Antoine LAIGLE, Paris (FR); Matthieu ATTALLI, Paris (FR)

(73) Assignee: SNECMA, Paris (FR)

(21) Appl. No.: 15/302,571

(22) PCT Filed: Apr. 7, 2015
(86) PCT No.: PCT/FR2015/050899

§ 371 Date: Oct. 7, 2016

(30) Foreign Application Priority Data
Apr. 8, 2014 (FR) 14 53097

(51) Int. Cl. F02C 9/46; B64D 37/32; F02C 7/232

(52) U.S. Cl. CPC F02C 9/46; F02C 7/232; B64D 37/32; F05D 2220/323; F05D 2240/35

(57) ABSTRACT

A supply system for supplying fluid to a turbomachine including a fluid tank, a downstream portion located downstream from the tank, and a cutoff valve located between the tank and the downstream portion. The cutoff valve is configured to be at least partially open when a rotational speed of a shaft of the turbomachine is higher than a first threshold and in the absence of a fire detected in the turbomachine. The cutoff valve is closed when the two following conditions are satisfied: the rotational speed of the shaft is higher than the first threshold, and the rotational speed of the shaft was lower than the first threshold when a fire was detected in the turbomachine during the flight.

### TECHNICAL DOMAIN

The invention relates to the technical domain of fluid supply systems for a turbomachine. More precisely, the invention relates to the isolation of a combustible fluid tank when there is a fire in a turbomachine.

### BACKGROUND OF THE INVENTION

Turbomachine lubrication systems are configured to allow a sufficient oil flow to cool the turbomachine in case of fire, in a known manner. This oil flow circulates under the effect of a lubricant supply pump driven by natural autorotation of the turbomachine when the aircraft is in flight.

However, when this oil flow is insufficient to cool the turbomachine during a fire, it is often necessary to limit the oil flow to turbomachine equipment and/or to provide specific protection of this equipment against fires. Specific protection systems against fires have the disadvantage of being large and heavy.

In order to limit the combustible fluid flow in a lubrication system in case of a fire in a turbomachine, it is known that the oil tank can be isolated from the remainder of the lubrication system by a cutoff valve that may be passive or may be controlled by a digital control system, so long as the fire is not definitively out.

Nevertheless, the use of a passive cutoff valve may be difficult to implement because it often means that the turbomachine will not be lubricated when the turbomachine is stopped. However, the digital control system of some turbomachines or some aircraft might not be available during a fire to control opening or closing of a controlled cutoff valve.

Furthermore, regulations in force make it necessary for the turbomachine to be able to resist a fire during a minimum duration, and making sure that no fuel is supplied to the fire at this time.

Therefore there is a need to isolate a combustible fluid tank of a turbomachine in the case of a fire, while limiting availability requirements of a digital control system, and the mass and dimensions of the turbomachine.

### PRESENTATION OF THE INVENTION

The invention aims at at least partially solving problems encountered in prior art solutions.

In this respect, the purpose of the invention is a method of isolating a combustible fluid tank from a downstream portion of a turbomachine fluid supply system,

the supply system including the tank and a cutoff valve located between the tank and the downstream portion,

the cutoff valve being configured to limit a fluid flow towards the downstream portion,

the cutoff valve being at least partially open when a rotational speed of a turbomachine shaft is greater than a first threshold and when no fire is detected in the turbomachine,

the isolation method including a step in which the valve is automatically closed when the shaft rotational speed is less than the first threshold.

Subsequent to the valve closing step, the method includes a step to limit/prevent subsequent opening of the cutoff valve if the shaft rotational speed is greater than the first threshold, when a fire is detected while the turbomachine is in flight.

In other words, when the shaft rotational speed is less than the first threshold and a fire has been detected during flight, the valve automatically closes and subsequent opening of the cutoff valve is limited/prevented.

In particular the cutoff valve remains closed when a fire has been detected in the turbomachine and the shaft rotational speed might be or might become insufficient to satisfactorily cool the equipment in the turbomachine to be supplied. Thus, the risk of supplying combustible fluid to the fire are limited, as is the need to provide special fire resistant protection for this equipment.

Therefore the method and the corresponding supply system are capable of isolating the combustible fluid tank in case of a fire inside the turbomachine, while limiting the mass and dimensions of the turbomachine, and in particular respecting legal requirements for the protection against fires inside a turbomachine.

Furthermore, the method can be easily automated mainly by taking account of the presence of a fire or the absence of a fire in the turbomachine. The need for availability of a digital control system is then limited.

The cutoff valve is closed when the shaft rotational speed is less than the first threshold. Lubrication chambers are then not supplied with lubricant when the shaft rotational speed is less than the first threshold.

The combustible fluid is preferably the lubricant, and particularly oil. As a variant, the fluid may be fuel.

Optionally, the invention may include one or several of the following characteristics, possibly but not necessary combined with each other.

In this configuration, subsequent opening of the cutoff valve is preferably limited/prevented until the end of the turbomachine flight.

In this case, the first threshold preferably corresponds to a sufficiently low rotational speed so that the turbomachine rotor does not have to be lubricated, and particularly the lubrication chambers.

Advantageously, a sufficient fluid flow to cool the turbomachine in case of fire circulates in the supply system, when the cutoff valve is open and the shaft rotational speed is greater than or equal to the first threshold.

The invention also relates to a turbomachine fluid supply system including:

a fluid tank,

a downstream portion located downstream from the tank and including a fluid supply pump, and

a cutoff valve located between the tank and the downstream portion,

the cutoff valve being configured to be open when a rotational speed of a turbomachine shaft is greater than the first threshold and when no fire is detected in the turbomachine,

According to the invention, when the shaft rotational speed is less than the first threshold, the cutoff valve closes automatically and subsequent opening of the cutoff valve is limited/prevented when a fire has been detected in flight.

In particular, the cutoff valve includes a locking device configured to limit/prevent opening of the cutoff valve.

Subsequent to the valve closing when the shaft rotational speed is less than the first threshold, the locking device is configured to limit/prevent subsequent opening of the cutoff valve if the shaft rotational speed is greater than the first threshold, when a fire is detected while the turbomachine is in flight.

According to another advantageous embodiment, the cutoff valve includes a safety position towards which the cutoff valve is returned if no control is applied to the cutoff valve, the cutoff valve being closed in the safety position.

Therefore the cutoff valve is closed or closes with limited action by a digital control system of the turbomachine or aircraft, or even with no action by the digital control system, during the critical event consisting of a fire.

The cutoff valve is preferably hermetically closed in the safety position. Nevertheless, some residual drops can flow, particularly downstream from the cutoff valve due to manufacturing and assembly tolerances of the cutoff valve.

It is also possible to avoid the need to duplicate controls of the cutoff valve by the digital control system because controls of the cutoff valve by the digital control system are no longer vital to protect the integrity of the turbomachine in case of fire.

Consequently, the supply system and the corresponding method can isolate a combustible fluid tank from the turbomachine in case of fire, while limiting the availability requirements of a digital control system.

Preferably, the locking device includes a locking element mobile between a blocking position in which the cutoff valve is blocked closed, and a release position in which the cutoff valve is configured to be closed or at least partially open,

the locking element being in the blocking position when no control is applied to the locking element such that the cutoff valve is in the safety position.

According to one special embodiment, the cutoff valve is pneumatically controlled when the locking element is in the release position.

As a variant, opening and/or closing of the cutoff valve is controlled by a digital control system of the turbomachine and/or the aircraft, when the locking element is in the blocking position.

A pneumatically controlled cutoff valve is preferably configured so that it is supplied with air from a turbomachine module chosen particularly from among a turbomachine compressor or a turbomachine turbine, the cutoff valve being configured to be open when the air pressure from the module exceeds a pressure threshold and the locking element is in the release position.

The valve may be opened and/or closed without action by the digital control system of the turbomachine and/or the aircraft, when the locking element is in the release position. Control of the cutoff valve has the advantage that it consumes only a small quantity of electrical energy.

The compressor is preferably a high pressure turbomachine compressor. Similarly, the turbine is preferably a high pressure turbine of a turbomachine.

The cutoff valve preferably comprises a piston and an elastic means mechanically connected to the piston while being configured to displace the piston to a first position in which the cutoff valve is closed, from a second position in which the cutoff valve is at least partially open.

When in the blocking position, the locking element preferably forms a piston stop, so as to prevent the piston from being in the second position.

According to a second advantageous embodiment, the locking element is configured to move from the blocking position to the release position when ordered by a turbomachine or aircraft digital control system.

The locking element is preferably bevelled, to facilitate displacement of the piston from the second position to the first position when the locking element is in the blocking position. Furthermore the bevelled shape of the locking element does not prevent the locking element in the blocking position from preventing movement of the piston from the first position to the second position.

The invention also relates to a turbomachine lubrication system comprising a supply system as defined above in which the supply system is configured to supply at least one lubrication compartment of the turbomachine, the lubrication system also comprising a lubricant return circuit comprising a lubricant return pump configured to supply lubricant from the lubrication chamber to the tank.

Finally, the invention relates to a turbomachine comprising a supply system and/or a lubrication system like that described above.

The turbomachine is preferably a turbojet or a turboprop. As a variant, the turbomachine is a helicopter engine.

### BRIEF DESCRIPTION OF THE DRAWINGS

The invention will be better understood after reading the description of example embodiments, given purely for information and in no way limitative, with reference to the appended drawings on which:

FIG. 1 shows a partial diagrammatic longitudinal sectional view of a turbomachine, according to a first embodiment of the invention;

FIG. 2 shows a partial diagrammatic view of a fluid supply system, according to the first embodiment of the invention;

FIG. 3 is an enlarged partial diagrammatic view of the cutoff valve of the supply system in FIG. 2, in the open position;

FIG. 4 is an enlarged partial diagrammatic view of the cutoff valve of the supply system in FIG. 3, in the closed position;

FIG. 5 diagrammatically illustrates a method of isolating the tank from the supply system shown in FIG. 2.

### DETAILED PRESENTATION OF PARTICULAR EMBODIMENTS

Identical, similar or equivalent parts of the different figures have the same numeric references to facilitate the comparison between different figures.

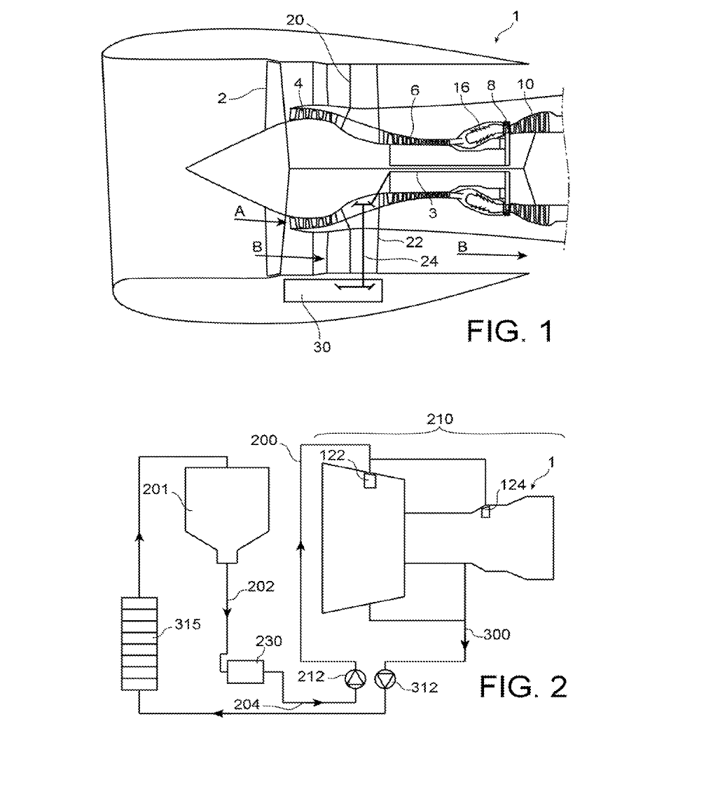

FIG. 1 shows a turbofan engine 1. The turbomachine 1 comprises in this order along the flow path of a core flow A a fan 2, a low pressure compressor 4, a high pressure compressor 6, a combustion chamber 16, a high pressure turbine 8 and a low pressure turbine 10.

The low pressure compressor 4, the high pressure compressor 6, the high pressure turbine 8 and the low pressure turbine 10 delimit a secondary bypass fan flow stream B that surrounds these components.

The high pressure compressor 6 and the high pressure turbine 8 are mechanically connected by a drive shaft 3 of the high pressure compressor 6 so as to form a high pressure body of the turbomachine 1. Similarly, the high pressure compressor 4 and the low pressure turbine 10 are mechanically connected by a shaft of the turbomachine 1, so as to form a low pressure case of the turbomachine 1.

The turbomachine 1 also comprises an intermediate case 20 through which radial struts 22 pass. One of the struts 22 comprises a radial shaft 24, the radially inner end of which is mechanically connected by gears to the drive shaft 3 of the high pressure compressor 6. The radially outer end of the radial shaft 24 is mechanically connected through gears to a gearbox 30 configured to act as an accessory gearbox for the turbomachine 1. Consequently, the gearbox 30 is configured so that it can be driven in rotation by the core engine.

The gearbox 30 is also known as the “accessory gearbox”. It comprises several items of equipment such as a lubricant supply pump 212, a fuel supply pump, a starter or an electric generator.

With reference to FIG. 2, the turbomachine 1 comprises a lubrication system including a lubricant supply system 200 and return circuit 300 leading to the lubricant reservoir 201. The supply system 200 is configured to supply at least one lubrication chamber 122, 124 of the turbomachine 1 from a lubricant reservoir 201. The lubrication chambers 122, 124 conventionally include equipment to be lubricated for nominal operation of the turbomachine 1.

A cutoff valve 230 of the lubricant supply from tank 201 is located between the tank 201 and the lubrication chambers 122, 124. The supply system 200 comprises the lubricant supply pump 212 between the cutoff valve 230 and the lubrication chambers 122, 124.

The lubricant supply pump 212 and the lubricant chambers 122, 124 form a downstream portion 210 of the supply system 200.

In this document, the “upstream” and “downstream” directions are defined by the general supply flow of the fluid that is lubricant in the first embodiment.

The lubricant return circuit 300 comprises a lubricant return pump 312 configured to supply the reservoir 201 with lubricant from the lubrication chambers 122, 124. Between the lubricant return pump 312 and the tank 201, the lubricant return circuit 300 includes a heat exchanger 315 configured to cool the lubricant, typically oil, before it returns into the tank 201. The heat exchanger 315 thus limits risks of premature degradation of the lubricant.

The cutoff valve 230 comprises a valve 237 configured to limit the fluid flow 202 from the tank 201 towards the supply pump 212. The “‘T-shaped” valve 237 is connected to one end of an arm 235 of the cutoff valve 230 through a hinge 236. The valve 237 is free to rotate about the hinge 240 of the valve 237, to be able to open and/or close the cutoff valve 230.

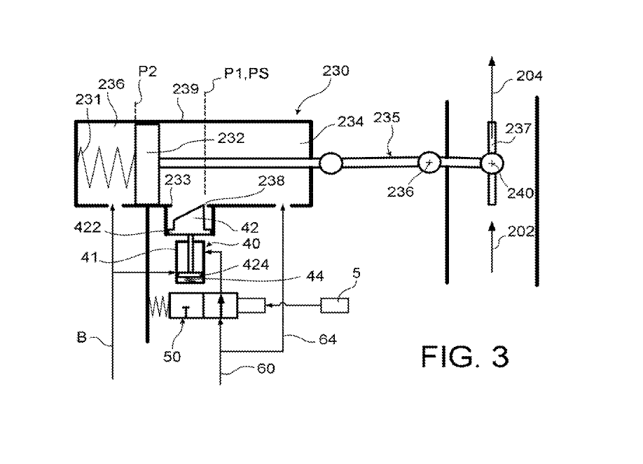

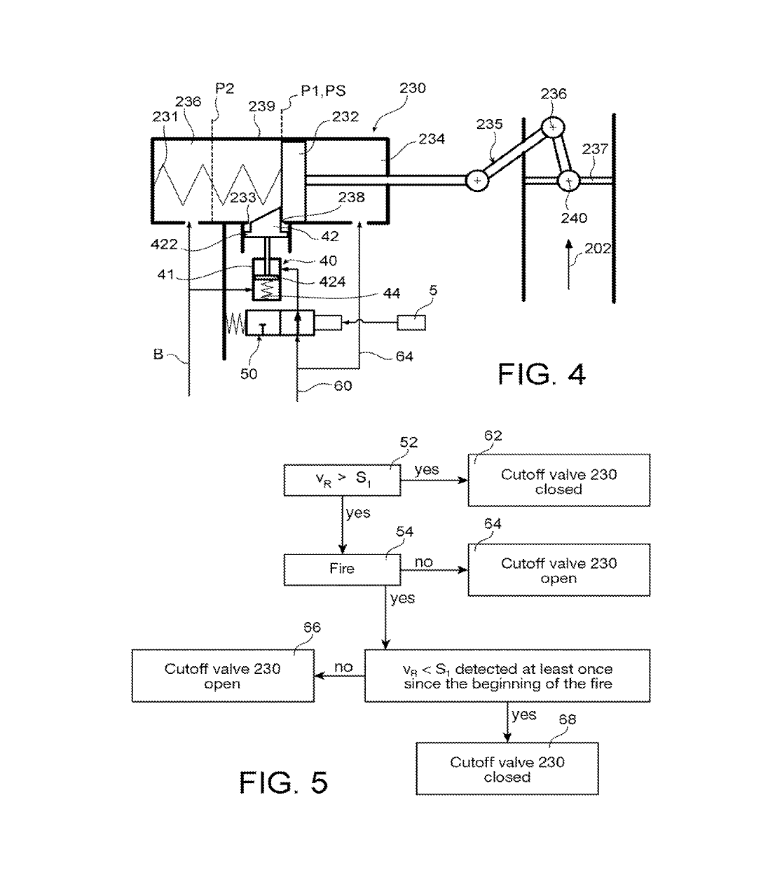

The valve 237 is free to move between an extreme open position in which the cutoff valve 230 is open on FIG. 3, and an extreme closed position in which the cutoff valve 230 is closed in FIG. 4. In the open position, the valve 237 does not limit the lubricant flow to the supply pump 212.

The cutoff valve 230 may possibly be partially open, in which case the valve 237 is between the open position and the closed position. As a variant, the cutoff valve 230 is an “Open-Close” valve in which the open position and the closed position are the only equilibrium positions of the valve 237.

The arm 235 is mechanically connected to a piston 232 at its end opposite the end of the valve 237, delimiting the volume of the two chambers 234, 236 of the cutoff valve 230. The piston 232 is free to move between a first position P1 in which the cutoff valve 230 is closed and the valve 237 is in the closed position, and a second position P2 in which the cutoff valve 230 is open and the valve 237 is in the open position.

The piston 232 is pushed towards the first position P1 by an elastic means 231 mechanically connected to the piston 232. The elastic means 231 may for example be a compression spring that tends to close the cutoff valve 230 or to keep it closed.

The piston 232 and the elastic means 231 are located inside a casing 239 of the cutoff valve 230, that with the piston, delimits the high pressure chamber 234 and the low pressure chamber 236 of the cutoff valve 230.

The high pressure chamber 234 is supplied with compressed air from a turbomachine module 1, chosen from among the high pressure compressor 6, the low pressure compressor 4, the high pressure turbine 8 and the low pressure turbine 10. In the first embodiment, the high pressure chamber 234 is supplied with compressed air along the direction of the arrow 64 by the high pressure compressor 6.

Ambient air is supplied to the low pressure chamber 236. This air originates particularly from the bypass flow B, such that a pressure difference between the low pressure chamber 236 and the high pressure chamber 234 generates displacement of the piston 232 against the spring acting as an elastic means 231, so as to balance the pressure inside the chambers 234 and 236, provided that the cutoff valve 230 did not remain blocked. In other words, the cutoff value 230 is pneumatically controlled when it is not blocked closed.

The cutoff valve 230 also comprises a locking device 40 configured to lock the cutoff valve 230 when the cutoff valve 230 is closed and the valve 237 is in the closed position.

The locking device 40 includes a locking element 42 mobile between a blocking position in which the cutoff valve 230 is blocked closed, preferably hermetically, and a release position in which the cutoff valve 230 is configured to be closed or at least partially open. In particular, the valve 237 can move from the closed position to the open position when the locking element 42 is in the release position. Conversely, the valve 237 remains in the closed position when the locking element 42 is in the blocking position.

In the first embodiment, the locking element 42 is in the form of a latch. The locking element 42 preferably acts as a stop for the piston 232, to prevent the piston 232 from being in the second position P2, in other words particularly to prevent the cutoff valve 230 from opening. The locking element 42 is bevelled, to facilitate displacement of the piston 232 from the second position P2 to the first position P1 when the locking element 42 is in the blocking position. Furthermore, the bevelled shape of the locking element 42 does not prevent the locking element 42 in the blocking position from preventing movement of the piston 232 from the first position P1 to the second position P2.

The latch 42 in the blocking position is configured to project into the low pressure chamber 236 from a through hole 238 made in the body 239 of the cutoff valve 230.

The latch 42 comprises in particular a projecting part 422 configured to engage an edge 233 of the casing 239 of the cutoff valve 230, so that the latch projects into the low pressure chamber 236 and is designed to prevent displacement of the piston 232 towards the second position P2.

The projecting part 422 is connected by a rod to piston 424 of the latch 42 located in a sleeve 41 of the piston 424. The sleeve 41 of the piston 424 comprises a return means 44 of the piston 424 configured to displace the piston 424 so that the locking element 42 is in the blocking position if no control is applied to the locking element 42.

In the release position, the latch 42 does not project into the low pressure chamber 236, so that it does not hinder displacement of the piston 232 between the first position P1 and the second position P2. In the release position the latch 42 compresses a return means 44 inside the sleeve 41.

The locking element 42 in the form of a latch is configured to move from the blocking position to the release position when ordered by a digital control system 5 of the turbomachine or aircraft.

In order to limit risks of failure in displacement of the locking element 42, the locking element 42 is controlled by the digital control system 5 preferably through an “On-Off” command, such that the only possible final positions of the locking element 42 are the blocking position and the release position. In this configuration, the blocking position is the only equilibrium position of the locking element 42 at rest.

The latch 42 is also displaced as a function of the arrival of air 60 from the high pressure compressor 6.

The digital control system 5 is also known as “FADEC” (Full Authority Digital Engine Control). Classically, the digital control system 5 comprises an engine computer with two symmetric redundant full authority channels. This engine computer will take account of a command from the aircraft pilot.

In the first embodiment, the digital control system 5 is configured to order a trigger electromagnet 50 to displace the latch 42 from the blocking position to the release position. The trigger electromagnet 50 is configured to transfer air under pressure into the sleeve 41 of the piston 424, so as to displace the latch 42 from the blocking position to the release position. If there is no control exerted by the digital control system 5 on the electromagnet 50, the electromagnet 50 is configured to block the arrival of air under pressure as shown by the arrow 60 in the sleeve 41.

If no control is applied to the latch 42, the return means 44 tends to bring the latch 42 into the blocking position in which the return spring 44 is at rest.

The return means 44 and the elastic means 231 thus form a safe closing means of the cutoff valve 230. This safety means brings the piston 232 towards the first position P1, if the digital control system 5 does not apply any control to the locking system 42.

The cutoff valve 230 then comprises a safety position PS in which the cutoff valve 230 is closed. The cutoff valve 230 is returned to its safety position PS if no pneumatic control and/or no control from the control system 5 is applied to the cutoff valve 230.

The locking element 42 is configured to move from the blocking position to the release position when ordered by the digital control system 5 when starting up the aircraft on which the turbomachine 1 is mounted, if there is no fire.

In this case, the cutoff valve 230 opens when the air pressure in the high pressure chamber 234 exceeds a pressure threshold that is greater than the pressure in the low pressure chamber 236. This pressure threshold of air from the high pressure compressor 6 is determined as a function of the first threshold S₁ of the rotational speed v_{R} of a shaft, the movement of which is linked to the rotation movement of the high pressure case of turbomachine 1. In the first embodiment, this shaft is the radial shaft 24. As a variant, it could possibly be the drive shaft 3 of the high pressure compressor 6.

The first threshold S₁ is determined such that the lubricant flow in the supply system 200 for values of the rotational speed v_{R} greater than the first threshold S₁ will be sufficient for efficient cooling of the turbomachine 1 during a fire.

The first threshold S₁ is also determined such that the rotational speed v_{R} of the radial shaft 24 is less than the first threshold S₁ if there is no fire, the rotor of the turbomachine 1 does not need any or does not need much lubrication. Moreover, the lubricant in the tank 201 is a combustible fluid that must not feed a fire in the turbomachine 1.

Consequently, the cutoff valve 230 is configured so that it is closed when the rotational speed v_{R} of the radial shaft is less than the first threshold S₁.

The cutoff valve 230 is configured to isolate the lubricant tank 201 in the downstream portion 210 of the supply system 200 in case of fire by the use of a method of isolating the tank 201 that is described with reference to FIG. 5.

Firstly, the rotational speed v_{R} of the radial shaft 24 is compared with the first threshold S₁ during an initialisation step of the method 52. When the rotational speed v_{R} is less than the first threshold S₁, the cutoff valve 230 is closed, in cases with and without a fire detected in the turbomachine 1.

When it is detected that the rotational speed v_{R} is greater than the first threshold S₁, the digital control system 5 determines during a step 54 of the isolation method if a fire is detected in the turbomachine 1, for example if an abnormal temperature rise is detected inside the turbomachine 1 by a temperature sensor.

If no fire is detected, the locking element 42 is held in the release position and the cutoff valve 230 is opened in step 64 due to the arrival 60 of compressed air from the high pressure compressor 6 when the rotational speed v_{R} is greater than the first threshold S₁. The lubrication chambers 122, 124 are then satisfactorily supplied with lubricant when there is no fire.

As soon as a fire is detected in the turbomachine 1 during flight of the turbomachine 1, the cutoff valve 230 is held open in step 66 only if the rotational speed v_{R} remained greater than the first threshold S₁ since the fire was detected.

Starting from the moment at which a fire was detected in the turbomachine 1 and the rotational speed v_{R} becomes at least temporarily less than the first threshold S₁, the piston 232 tends to move from the second position P2 to the first position P1 when the locking element 42 is in the release position.

When the piston 232 has reached the first position P1, the locking element 42 changes to the blocking position in step 66, such that the cutoff valve 230 is blocked closed. The cutoff valve 230 then preferably remains closed by the locking element 42 by precaution until the end of the flight of the turbomachine 1.

In other words, when the rotational speed v_{R} is less than the first threshold S₁ and a fire is detected in the turbomachine 1, the valve 230 automatically closes and subsequent opening of the cutoff valve 230 during the flight is limited/prevented.

More generally, the cutoff valve 230 is closed when the following two conditions are combined:
the rotational speed v_{R} of the radial shaft 24 is greater than the first threshold S₁, and
the rotational speed vR of the radial shaft has been lower than the first threshold S₁ when a fire was detected in the turbomachine 1 during flight of the turbomachine 1.

The invention makes it easier to respect regulatory requirements concerning fire regulations in a turbomachine 1, particularly by limiting the use of large and heavy special fire prevention protections in the turbomachine 1.

In particular, the risk that the cutoff valve 230 does not close in the case of a fire in the turbomachine 1 is limited by the safety means consisting of the return spring 44 and the elastic means 231, that tends to bring the cutoff valve 230 towards its safety position PS in which the cutoff valve 230 is closed.

Obviously, an expert in the subject could make various modifications to the invention that has just been described without going outside the framework of the presentation of the invention.

1-9. (canceled)

10. A method of isolating a combustible fluid tank from a downstream portion of the fluid supply system for a turbomachine,
the supply system including the tank and a cutoff valve located between the tank and the downstream portion, wherein the cutoff valve is configured to limit a fluid flow towards the downstream portion,
wherein the cutoff valve is at least partially open when a rotational speed of a turbomachine shaft is greater than a first threshold and when no fire is detected in the turbomachine,
the isolation method including a step in which the valve is automatically closed when the rotational speed of the shaft is less than the first threshold,
wherein, subsequent to the closing step of the valve, the method includes a step of limiting/preventing subsequent opening of the cutoff valve if the shaft rotational speed is greater than the first threshold, when a fire is detected while the turbomachine is in flight.

11. The isolating method according to claim 10, wherein a sufficient fluid flow to cool the turbomachine in case of fire circulates in the supply system, when the cutoff valve is open and the rotational speed is greater than or equal to the first threshold.

12. A fluid supply system for a turbomachine comprising:
a fluid tank,
a downstream portion located downstream from the tank and including a fluid supply pump, and
a cutoff valve located between the tank and the downstream portion, the cutoff valve including a locking device configured to limit/prevent opening of the cutoff valve,
wherein the cutoff valve is configured to be at least partially open when a rotational speed of a turbomachine shaft is greater than a first threshold and when no fire is detected in the turbomachine,
wherein the cutoff valve is configured to close automatically when the rotational speed of the shaft is less than the first threshold,
wherein, subsequent to the valve closing when the rotational speed of the shaft is less than the first threshold, the locking device is configured to limit/prevent subsequent opening of the cutoff valve if the shaft rotational speed is greater than the first threshold, when a fire is detected while the turbomachine is in flight.

13. The supply system according to claim 12, wherein the cutoff valve includes a safety position towards which the cutoff valve is returned if no control is applied to the cutoff valve, wherein the cutoff valve is closed in the safety position.

14. The supply system according to claim 13, wherein the locking device includes a locking element mobile between a blocking position in which the cutoff valve is blocked closed, and a release position in which the cutoff valve is configured to be closed or at least partially open,
wherein the locking element is in the blocking position when no control is applied to the locking element such that the cutoff valve is in the safety position.

15. The supply system according to claim 14, wherein the cutoff valve is pneumatically commanded when the locking element is in the release position.

16. The supply system according to claim 14, wherein the locking element is configured to move from the blocking position to the release position when ordered by a turbomachine or aircraft digital control system.

17. The supply system according to claim 12, wherein the cutoff valve comprises a piston and an elastic means mechanically connected to the piston, wherein the elastic means is configured to displace the piston to a first position in which the cutoff valve is closed, from a second position in which the cutoff valve is at least partially open.

18. A turbomachine comprising a supply system according to claim 12.
